(19) United States
(12) Patent Application Publication
(10) Pub. No.: US 2023/0118167 A1
(43) Pub. Date: Apr. 20, 2023

(54) DUAL-RECEIVING AND DUAL-TRANSMITTING TWO-WAY RADIO

(71) Applicant: Guangdong Samzuk Technology Development Co., Ltd., Heyuan City (CN)

(72) Inventors: Jun Liu, Heyuan City (CN); Huiqun Wang, Heyuan City (CN)

(21) Appl. No.: 17/520,198

(22) Filed: Nov. 5, 2021

(30) Foreign Application Priority Data
Oct. 19, 2021 (CN) 202122519120.0

(51) Int. Cl. H04W 4/10; H04B 1/3827

(52) U.S. Cl. CPC H04W 4/10; H04B 1/3833

(57) ABSTRACT

A dual-receiving and dual-transmitting two-way radio including a radio communication module and a control module. The radio communication module is configured to receive and transmit a communication signal on a primary channel or a secondary channel; the control module controls the radio communication module to monitor a communication signal on the primary channel and the secondary channel alternately, and controls the radio communication module to transmit a communication signal on the primary channel or the secondary channel; the radio communication module has a function of receiving and transmitting a communication signal on the primary channel and the secondary channel in separate periods, and the control module is also capable of selecting working channel numbers of the primary channel and the secondary channel respectively.

### CROSS REFERENCE TO RELATED APPLICATION

This application claims the benefit and takes priority from the Chinese Patent Application No. 202122519120.0 filed on Oct. 19, 2021, the contents of which are herein incorporated by reference.

### BACKGROUND OF THE INVENTION

### Field of the Invention

The present disclosure relates to the technical field of two-way radio communications, and in particular to a dual-receiving and dual-transmitting two-way radio.

### Description of the Related Art

With the continuous development of social economy, two-way radios are used more and more widely, with greater demand in service industry, personal self-driving and succor organizations.

Present two-way radios can receive communication signals on a single channel only. In order to solve the problem of receiving communication signals on two channels, dual-channel receiving two-way radios appear, which can monitor communication signals on two different channels alternately; however, by simply operating a button the dual-channel receiving two-way radios can transmit a communication signal on the primary channel only and cannot transmit a communication signal on the secondary channel, which are inconvenient in use.

The prior art has a problem that a communication signal cannot be transmitted on a secondary channel by simply operating a button.

### SUMMARY OF THE INVENTION

In view of the above, the present disclosure aims to provide a dual-receiving and dual-transmitting two-way radio, so as to overcome the problem that a communication signal cannot be transmitted on a secondary channel by simply operating a button so far.

In order to achieve the above aim, the present disclosure employs the following technical scheme.

A dual-receiving and dual-transmitting two-way radio includes a shell, a mainboard, a radio communication module, a control module, a sound pickup module, a loudspeaker module and a power module, wherein

the mainboard is arranged in the shell; the radio communication module, the control module, the sound pickup module and the loudspeaker module are arranged on the mainboard; the power module is electrically connected to the radio communication module, the control module, the sound pickup module and the loudspeaker module respectively; the control module is electrically connected to the radio communication module, the loudspeaker module and the sound pickup module respectively; the loudspeaker module is electrically connected to a corresponding end of the radio communication module; and the sound pickup module is electrically connected to a corresponding end of the radio communication module.

Further, for the above dual-receiving and dual-transmitting two-way radio, the shell is provided with a PPT button which is configured to transmit a communication signal on a primary channel, and the PPT button is electrically connected to the control module.

Further, for the above dual-receiving and dual-transmitting two-way radio, the shell is provided with a GROUP button which is configured to transmit a communication signal on a secondary channel, and the GROUP button is electrically connected to the control module.

Further, for the above dual-receiving and dual-transmitting two-way radio, the shell is provided with a channel switch button which is configured to select an available working channel number for the primary channel and the secondary channel respectively, and the channel adjustment button is electrically connected to the control module.

Further, for the above dual-receiving and dual-transmitting two-way radio, the loudspeaker module includes a loudspeaker.

Further, for the above dual-receiving and dual-transmitting two-way radio, the power module includes an independent power supply.

The present disclosure has the following advantages. The dual-receiving and dual-transmitting two-way radio includes a radio communication module and a control module, wherein the radio communication module is configured to receive and transmit a communication signal on the primary channel and the secondary channel in separate periods, the control module controls the radio communication module to monitor a communication signal on the primary channel and the secondary channel alternately, and controls the radio communication module to transmit a communication signal on the primary channel or the secondary channel; the employed radio communication module can receive and transmit a communication signal on the primary channel or the secondary channel, the employed control module can control the radio communication module to transmit a communication signal on the secondary channel, thereby achieving the function of simply operating a button to fire the wireless transmission on the secondary channel.

### BRIEF DESCRIPTION OF THE DRAWINGS

For a better understanding of the technical scheme in the embodiments of the present disclosure or in the prior art, accompanying drawings needed in the description of the embodiments or the prior art are simply illustrated below. Obviously, the accompanying drawings described below are some embodiments of the present disclosure. For the ordinary skill in the field, other accompanying drawings may be obtained according to these accompanying drawings without creative work.

FIG. 1 is a structure diagram of one embodiment of a dual-receiving and dual-transmitting two-way radio according to the present disclosure.

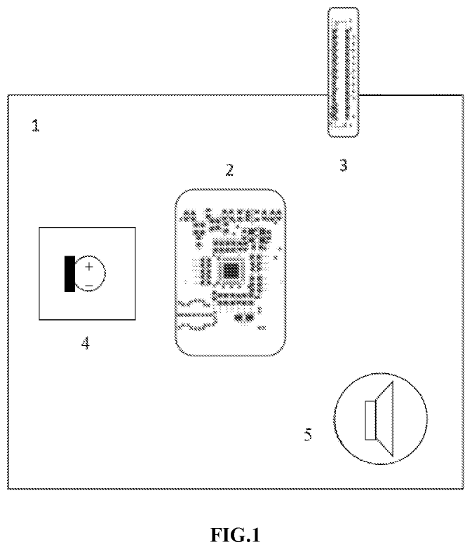

FIG. 2 is a diagram of signal transmission of a dual-receiving and dual-transmitting two-way radio according to the present disclosure.

### DETAILED DESCRIPTION OF THE SEVERAL EMBODIMENTS

The above purpose, technical scheme and advantages of the present disclosure will become more clearly understood from the detailed description of the technical scheme of the present disclosure provided below. Obviously, the embodiments described hereinafter are simply part embodiments of the present disclosure, but all the embodiments. All other embodiments obtained by those skilled in the art based on the embodiments in the present disclosure without creative work are intended to be included in the scope of protection of the present disclosure.

The prior art has a problem that a communication signal cannot be transmitted on a secondary channel by simply operating a button. In order to solve the above problem, the present disclosure provides the following embodiments.

### Embodiments

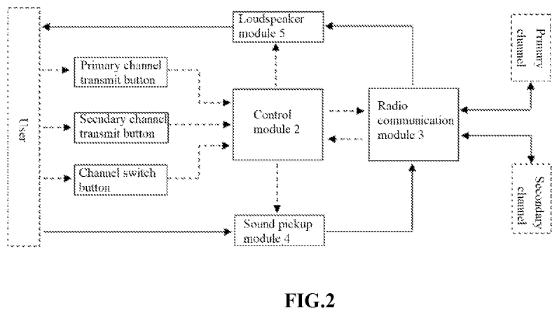

As shown in FIG. 2 and FIG. 2, the present embodiment provides a dual-receiving and dual-transmitting two-way radio, including a shell, a mainboard 1, a radio communication module 3, a control module 2, a sound pickup module 4, a loudspeaker module 5 and a power module, wherein

the mainboard 1 is arranged in the shell; the radio communication module 3, the control module 2, the sound pickup module 4 and the loudspeaker module 5 are arranged on the mainboard 1; the power module is electrically connected to the radio communication module 3, the control module 2, the sound pickup module 4 and the loudspeaker module 5 respectively; the control module 2 is electrically connected to the radio communication module 3, the loudspeaker module 4 and the sound pickup module 5 respectively; the loudspeaker module 5 is electrically connected to a corresponding end of the radio communication module 3; and the sound pickup module 4 is electrically connected to a corresponding end of the radio communication module 3.

After connected to the power supply, if the radio communication module 3 does not detect any communication signal, the control module 2 controls the radio communication module 3 to monitor on the primary channel and the secondary channel alternately whether there is a valid communication signal, in the meantime the control module 2 controls the loudspeaker module 5 to keep in an off state, that is, the loudspeaker has no sound.

When the radio communication module 3 detects that there is a valid communication signal on the primary or secondary channel, the radio communication module 3 sends data to the control module 2, the control module 2 controls the loudspeaker module 5 to turn on, the loudspeaker module 5 amplifies the audio signal demodulated and output from the radio communication module 3 and pushes the loudspeaker to make a sound. In the meantime, if the radio communication module 3 detects that the signal on the current receiving channel becomes invalid, the radio communication module 3 sends data to the control module 2, the control module 2 controls the loudspeaker module 5 to stop working and controls the radio communication module 3 to continue monitoring a communication signal on the current channel within a preset time. In some optional embodiments, the radio communication module 3 continues monitoring a communication signal on the current channel within 5 seconds. If within the set time, the radio communication module 3 does not detect any valid communication signal, the control module 2 controls the radio communication module 3 to monitor a communication signal on the primary channel and the secondary channel alternately; if within the set time, the radio communication module 3 detects again a valid communication signal, the control module 2 controls the loudspeaker module 5 to turn on, that is, repeating from the start step of the receiving operation process.

Once the users press and hold down one of “PTT” and “GROUP” buttons, the sound pickup module 4 will pick up a sound and then convert it into audio signal and deliver it to the radio communication module 3, and the control module 2 controls the radio communication module 3 to transmit the communication signal to the primary channel or the secondary channel depending on which of “PPT” and “GROUP” button is pressed.

It should be noted that the computer programs involved in the present embodiment are available technology, they can be realized through a single-chip, for example, through 80051 series of single-chips. No further description is needed in the present embodiment.

The employed radio communication module in the present disclosure can receive and transmit a communication signal on the primary channel or the secondary channel, the employed control module can control the radio communication module to transmit a communication signal on the secondary channel, thereby achieving the function of simply operating a button to fire the wireless transmission on the secondary channel.

Further, the shell is provided with a PPT button which is configured to transmit a communication signal on a primary channel, and the PPT button is electrically connected to the control module 2, for easing transmitting a communication signal on the primary channel actively.

Further, the shell is provided with a GROUP button which is configured to transmit a communication signal on a secondary channel, and the GROUP button is electrically connected to the control module 2, for easing transmitting a communication signal on the secondary channel actively.

Further, the shell is provided with a channel switch button which is configured to select an available working channel number for the primary channel and the secondary channel respectively, and the channel adjustment button is electrically connected to the control module 2, for easing changing the working channel number for the two kinds of channels.

Further, the loudspeaker module 5 is a loudspeaker, which can improve the sound quality.

Further, the sound pickup module 4 is a microphone sensor, which can improve the efficiency of picking up sound.

It is understandable that the same or similar parts in each above embodiment can refer to each other; those contents not described in detail in some embodiments can refer to the same or similar contents in other embodiments.

It should be noted that, in the description of the present disclosure, terms “first”, “second”, etc. are merely for the purpose of description, but cannot be understood as the indication or implication of relative importance. In addition, in the description of the present disclosure, unless otherwise stated, “a plurality of” means at least two.

In the description of the specification, referring to terms such as “one embodiment”, “some embodiment”, “example”, “specific example”, or “examples” means that the specific features, structures, materials, or features described in combination with the embodiment or example are included in at least one embodiment or example of the present disclosure. In the specification, indicative expressions of the above terms do not necessarily refer to the same embodiments or examples. Moreover, the specific features, structures, materials or features described may be combined in an appropriate manner in any one or more embodiments or examples.

Although the above has shown and described the embodiments of the present disclosure, it is understandable that the above embodiments are exemplary and cannot not be viewed as restrictions to the present disclosure. The ordinary skill in the art can perform modifications, changes, substitutions and transformations on the above embodiments within the scope of the present disclosure.

1. A dual-receiving and dual-transmitting two-way radio, comprising:
a shell;
a mainboard;
a radio communication module;
a control module;
a sound pickup module;
a loudspeaker; and
a power module;
wherein the mainboard is arranged in the shell, and the radio communication module, the control module, the sound pickup module and the loudspeaker module are arranged on the mainboard;
wherein the power module is electrically connected to the radio communication module, the control module, the sound pickup module and the loudspeaker module respectively, and the control module is electrically connected to the radio communication module, the loudspeaker module and the sound pickup module respectively, and the loudspeaker module is electrically connected to a corresponding end of the radio communication module, and the sound pickup module is electrically connected to a corresponding end of the radio communication module; and
wherein, a detection of a sound by the sound pickup module converts the sound to an audio signal which is transmitted to the radio communication module in order for the control module to push the audio signal to a primary channel and/or a secondary channel, and wherein the presence or lack of the sound and the subsequent audio signal is detected by the radio communication module that sends the audio signal to the control module to project the sound through the loudspeaker when the sound is detected.

2. The dual-receiving and dual-transmitting two-way radio according to claim 1, wherein the shell is provided with a PPT button which is configured to transmit a communication signal on a primary channel, and the PPT button is electrically connected to the control module.

3. The dual-receiving and dual-transmitting two-way radio according to claim 1, wherein the shell is provided with a GROUP button which is configured to transmit a communication signal simultaneously on a primary and secondary channel, and the GROUP button is electrically connected to the control module.

4. The dual-receiving and dual-transmitting two-way according to claim 1, wherein the shell is provided with a channel switch button which is configured to select an available working channel number for the primary channel and the secondary channel respectively, and the channel adjustment button is electrically connected to the control module.

5. The dual-receiving and dual-transmitting two-way radio according to claim 1, wherein the loudspeaker module comprises a loudspeaker.

6. The dual-receiving and dual-transmitting two-way radio according to claim 1, wherein the power module comprises an independent power supply.
